(19) United States
(12) Patent Application Publication
(10) Pub. No.: US 2007/0289555 A1
(43) Pub. Date: Dec. 20, 2007

(54) Soft terrain portable dog restraint system

(76) Inventor: Thomas Richard Campbell, San Jose, CA (US)

Correspondence Address: THOMAS RICHARD CAMPBELL, 1555 GUADALAJARA DR, SAN JOSE, CA, 95120, US

(21) Appl. No.: 11/451,169

(22) Filed: Jun. 12, 2006

(51) Int. Cl. A01K 1/04

(52) U.S. Cl. 119/786

(57) ABSTRACT

Current product offerings do not provide for a light-weight, portable dog restraint system for soft terrain, particularly for beach locations. Many states have enacted laws that require a dog to be on a leash while on a beach. This requirement makes it difficult for dog owners to restrain their dogs and simultaneously enjoy the beach. The challenge is to find a way to provide enough resistance to restrain a dog in a soft terrain setting. This challenge is addressed by a product which allows for appropriate weight to be added to the restraint system on location. The restraint system consists of a hollowed receptacle which can be filled with sand or water at the beach location. The hollow receptacle is then closed by a sleeve that screws into the hollow base. The sleeve consists of a center core wrapped by a pipe and eye-bolt system that rotates 360 degree around the center core. This allows the dog to be tethered, but have a free range of motion around the restraint system base. The top of the sleeve is hollow to allow for an umbrella or other shade system to be implemented to provide a shady rest sport for the dog. Finally, the restraint system base has two receptacles covered by doors. These receptacles are for food and water for the dog.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Currently, there are no products on the market that provide a dog owner with a solution to restrain their dog in soft terrain such as sand at a beach, lake or river.

Many State Beaches and National Parks require that a dog be on a leash at all times in these locations.

Dog owners are limited in their ability to enjoy the full benefits of State Beaches and National Parks due to the fact that they have to leash their dogs and have no portable, convenient solution to restrain them in these locations.

A lightweight, portable solution that allows the dog owner to restrain his dog in a soft terrain environment without the burden of holding the leash the entire time in a soft terrain location would be very convenient for dog owners.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

The present invention is a dog restraint system for use in soft terrain, or a Soft Terrain Dog Restraint System.

This Soft Terrain Dog Restraint System consists of a hollow base unit and a rotating leash tethering system that encloses the system.

This Soft Terrain Dog Restraint System is lightweight and allows appropriate weight to be added on location either by using the soft terrain in the landscape or nearby water source.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

The numerous objects and advantages of the present invention may be better understood by those skilled in the art by reference to the accompanying figures in which:

FIG. 1 is a perspective diagram of the components of a Soft Terrain Dog Restrain System.

FIG. 2 is a perspective diagram of an overhead view of a Soft Terrain Dog Restraint System showing the 360 degree rotation of the leash tethering sleeve.

FIG. 3 is a perspective diagram of the Soft Terrain Dog Restraint System being filled with sand to provide the appropriate weight to secure the system in sand or other soft terrain.

FIG. 4 is a perspective diagram of the Soft Terrain Dog Restraint System deployed to restrain a dog and to provide shade cover for the dog.

FIG. 5 is a Flow Diagram showing the steps for using the Soft Terrain Dog Restraint System.

### DETAILED DESCRIPTION OF THE INVENTION

The present invention relates generally to the ability to restrain a dog in soft terrain where current restraint systems are not applicable, and, more specifically, to the ability to restrain a dog in a beach location.

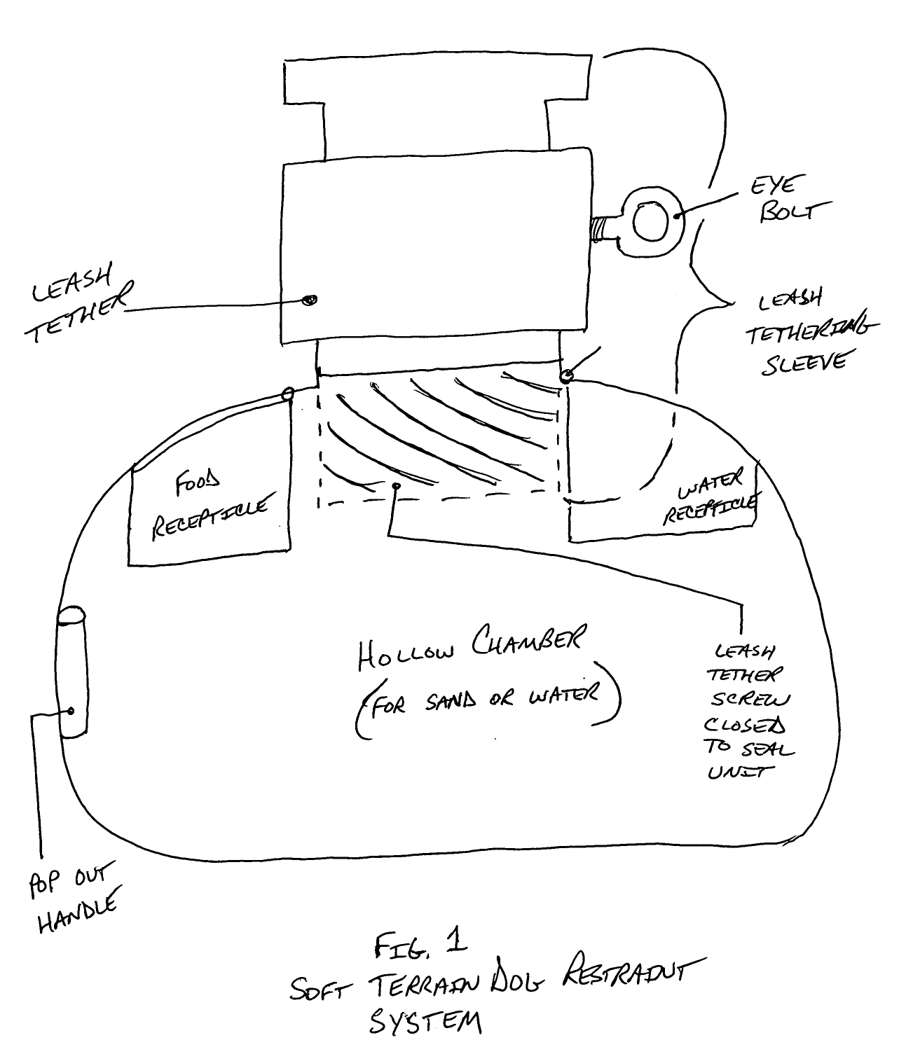

FIG. 1 is a perspective diagram of the components of a Soft Terrain Dog Restraint System.

The Soft Terrain Dog Restraint System is made from lightweight material and has a hollow base.

The base includes hollow receptacles with hinged doors to allow for convenient and safe storage of food and water for the dog.

The base also includes a hinged handle for easy transport of the system.

The top of the base is sealed with a leash tethering sleeve that screws into the hollow base.

The top of the leash tethering sleeve is hollow to allow for a pole umbrella or other shade system to be used in conjunction with the Soft Terrain Dog Restraint System.

The leash tethering sleeve is comprised of a central shaft around which the leash tether can rotate 360 degrees.

The leash tether is comprised of a hollow pipe with an eye bolt on the pipe's outer circumference.

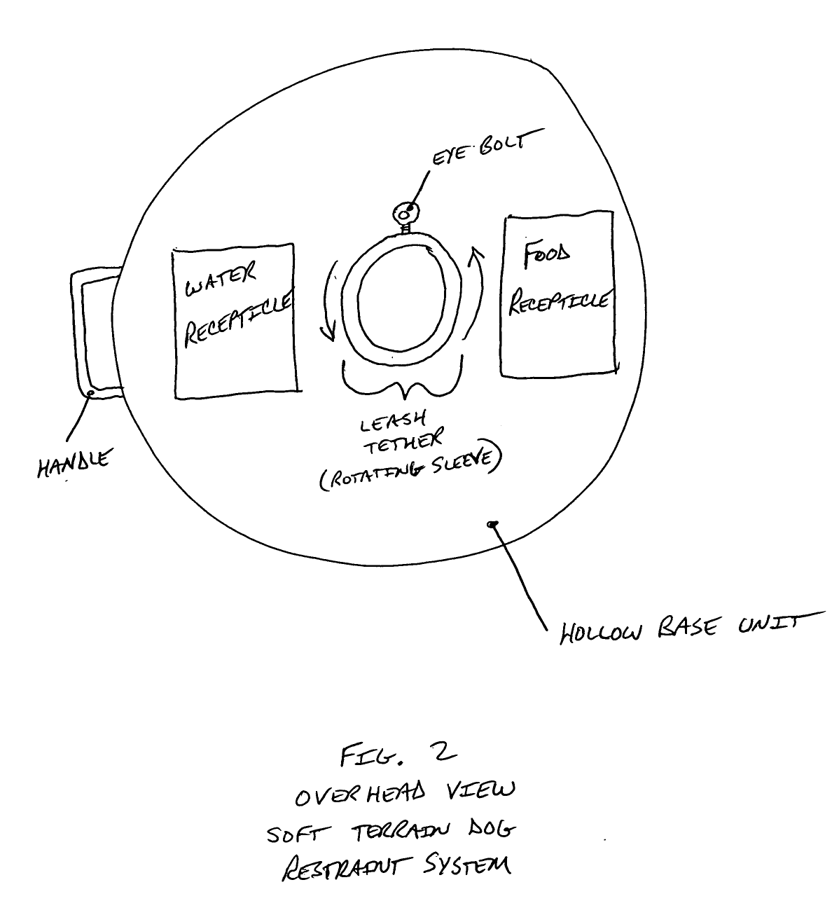

FIG. 2 is a perspective diagram of an overhead view of a Soft Terrain Dog Restraint System showing the 360 degree rotation of the leash tethering sleeve.

The leash tethering sleeve allows the dog a full range of motion around the base unit while preventing the leash from tangling or being wrapped around the base unit.

The food and water receptacles are also shown in this view.

The handle for easy transport of the unit is also shown in this view.

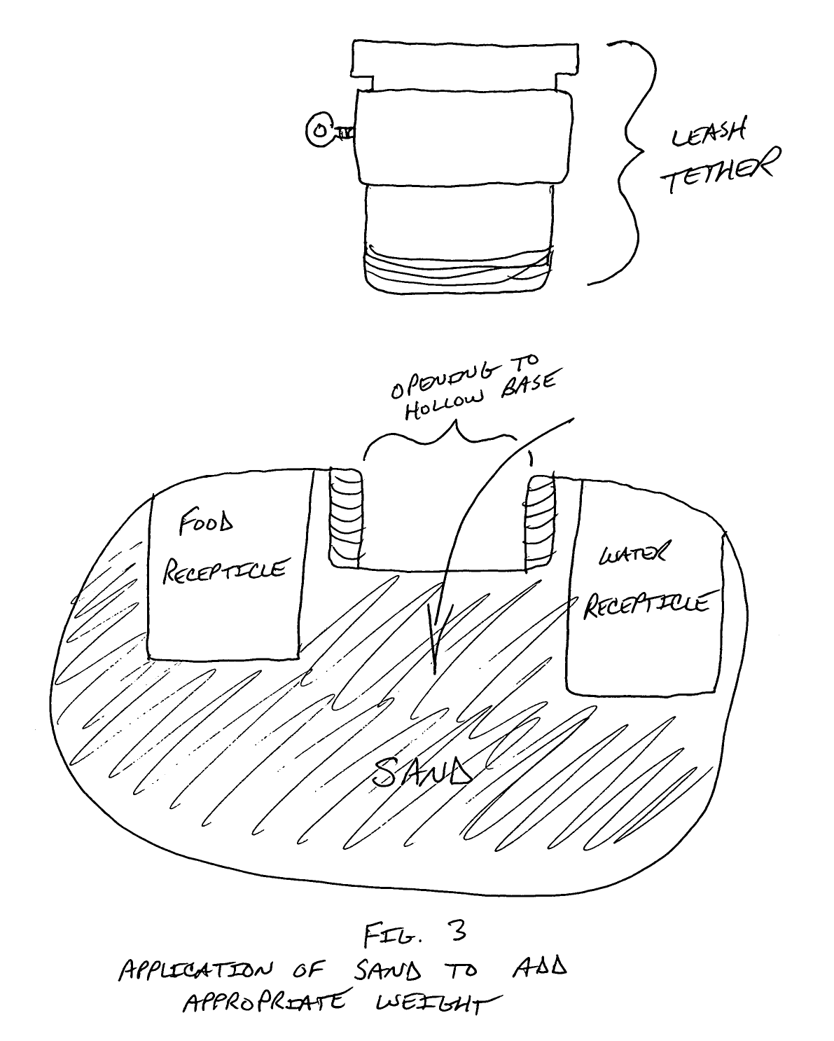

FIG. 3 is a perspective diagram of the Soft Terrain Dog Restraint System being filled with sand to provide the appropriate weight to secure the system in sand or other soft terrain.

The Soft Terrain Dog Restraint System is filled with sand or other soft terrain to provide the appropriate amount of weight to stop a dog from moving beyond the circumference of the leash length attached to the base unit.

The leash tethering sleeve is then screwed into the base unit to close it.

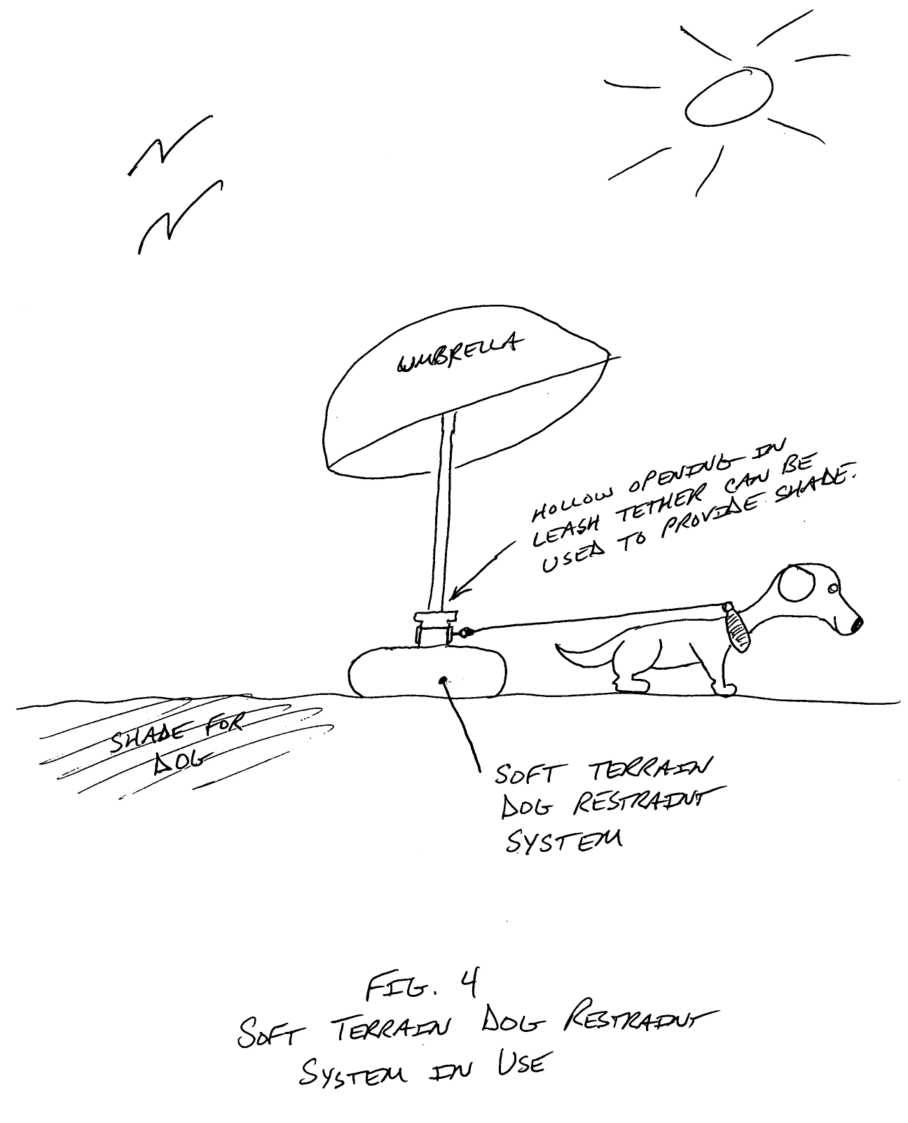

FIG. 4 is a perspective diagram of the Soft Terrain Dog Restraint System deployed to restrain a dog and to provide shade cover for the dog.

A leashed dog can be tethered to the Soft Terrain Dog Restrain System via a metal clip attached to the dog's leash and to the eye bolt on the leash tethering system.

The leash tethering system's hollow opening doubles as an umbrella or shade system holder to provide shade for any dog tethered to the Soft Terrain Dog Restraint System.

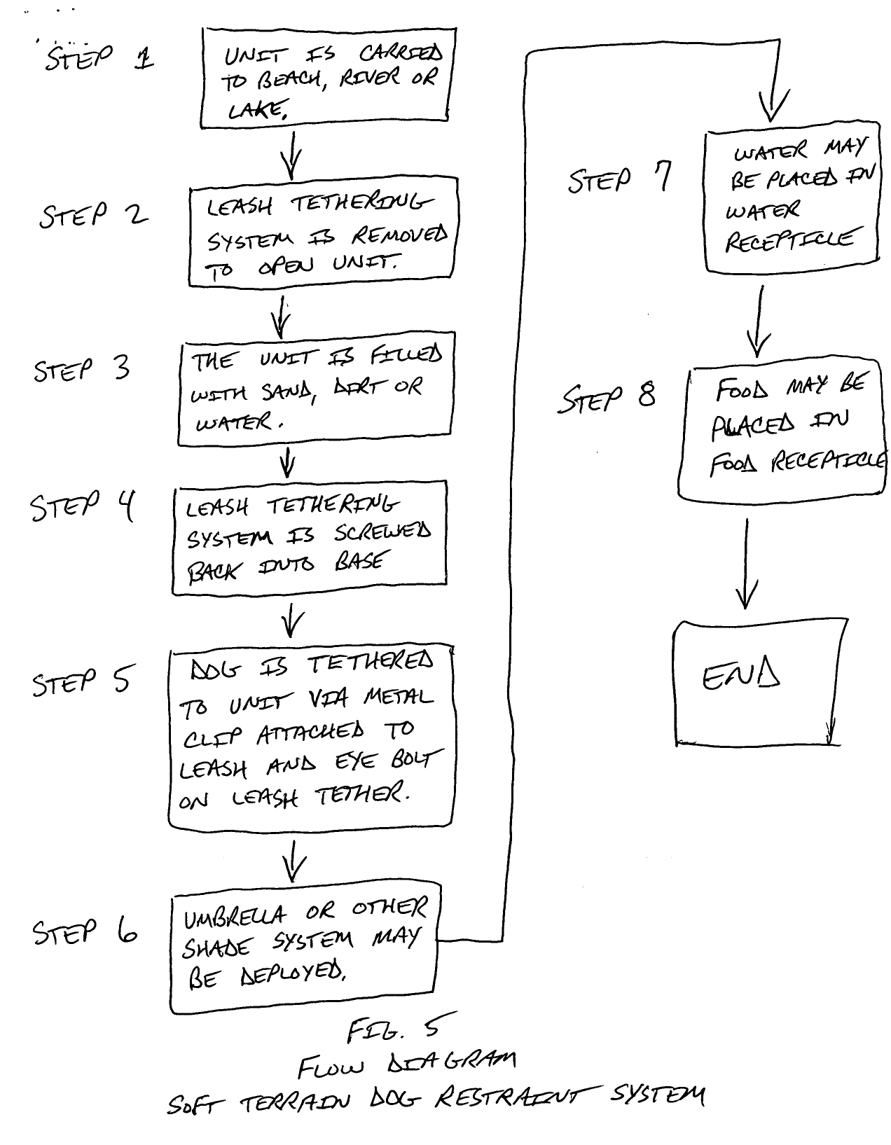

FIG. 5 details the steps required for to deploy the Soft Terrain Dog Restraint System.

Step 1: The lightweight Soft Terrain Dog Restraint System is carried by its handle to a beach, river or lake.

Step 2: The leash tethering system is removed to reveal opening to hollow base.

Step 3: The hollow base unit is filled with sand or dirt to provide enough weight to adequately restrain the dog.

Step 4: The leash tethering system is screwed back into the base unit to close the opening.

Step 5: The dog is tethered to the Soft Terrain Dog Restraint System via a metal clip attached to the leash and to the eye bolt on the leash tethering system.

Step 6: An umbrella or other shade system can be used to provide shade for the dog.

Step 7: Water for the dog can be placed in the water receptacle.

Step 8: Food for the dog can be placed in the food receptacle.

Step 9: These processes are reversed to finish use of the Soft Terrain Dog Restraint System.

Although a system and method according to the present invention has been described in connection with the preferred embodiment, it is not intended to be limited to the specific form set forth herein, but on the contrary, it is intended to cover such alternative, modifications and equivalents, as can be reasonably included within the spirit and scope of the invention as defined by this disclosure and appended diagrams.

What is claimed is:

1. A dog restraint system for use in soft terrain.

2. A portable Soft Terrain Dog Restraint System that allows for weight to be added at on location via water or soft terrain.

3. A Rotating Leash Tethering System that provides for 360 degree movement around the Soft Terrain Dog Restraint System.

4. The Leash Tethering System also acts as a mechanism for sealing the base unit of the Soft Terrain Dog Restraint System.

5. A handle on the base unit for easy transport.

6. Food and Water Receptacles included in the base unit.

7. The Leash Tethering System also acts as a mechanism for holding an umbrella or other shade system.
